(19) United States
(12) Patent Application Publication
(10) Pub. No.: US 2008/0308138 A1
(43) Pub. Date: Dec. 18, 2008

(54) Folding Roof Tent for Motor Vehicle Comprising a Compartment Accessible from Both the Inside and Outside of the Tent

(76) Inventors: Patrice Jean Marie Alain Brochier, Saint Privat des Vieux (FR); Christian Soteau, Vigneux Sur Seine (FR)

Correspondence Address: Patrice Brochier, Chemin de la Vabre, Saint Privat des Vieux, 30340, omitted

(21) Appl. No.: 12/158,368

(22) PCT Filed: Jan. 5, 2007
(86) PCT No.: PCT/FR2007/000010

§ 371 Date: Aug. 8, 2008

(30) Foreign Application Priority Data
Jan. 9, 2006 (FR) 0600163

(51) Int. Cl. E04H 15/06; B60R 9/055

(52) U.S. Cl. 135/88.17; 135/88.16

(57) ABSTRACT

The invention relates to a car roof tent that attaches to the roof bars and offers storage space for the user's luggage in a compartment that is an integral part of the roof tent but which offers two means of access: external access and internal access. When the tent is closed, the user gains access from the outside to his luggage situated inside the compartment through a separate cover (3). Since the compartment part is integrated, the user also has access to it from the inside when the tent is open (tent cover (2) open) and he himself is inside the tent. He is therefore not obliged to keep going in and out between the inside of the tent and the vehicle, where his luggage would otherwise be stored. Moreover, given such a compartment, the luggage is available without clambering over the inhabitable space or through the tent sleeping area. The compartment may be on the opposite side or on one of the sides of the entrance of the roof tent. This concept of a dual-access compartment applies to roof tents in general. The roof tent according to the invention is particularly intended for those who wish to do touring camping by car.

The present invention relates to a roof tent for motor vehicle equipped with a compartment for luggage whose access to is possible either from the inside of the tent, or from the outside when this one is closed. The roof tent is designed with aerodynamic pattern when closed: it is the driving position. The position open of the roof tent is used when occupied, the vehicle being parked.

Roof tents currently known, or marketed, when closed do not allow access to luggage stored in their inside, without having to open them. Also the users inside the tent are forced to leave the tent to reach their luggage, stored in the inside of the vehicle. But this action of coming out is not easy and could be tiresome in many cases. For example, to fetch necessary items left behind such as nightclothes, flashlight, medicine etc. . . . the user must put shoes on, go down the ladder, open the vehicle, and search his bags, this could be worse whenever weather condition is bad, further more the bags can't be stored overnight inside the tent, because the lying area in currently available roof tents don't allow it.

The principle used by this invention intends to remedy to this disadvantage.

One part of the roof tent is a compartment that has an access opening outside, also an opening that allows access from the inside of the tent.

Thus, the user of the roof tent is able to gain access at any time to the compartment part, to put in or take out his luggage, when the roof tent is set at the driving position. And when the tent is folded out, position inhabitable with the vehicle to a halt, the user inside the tent is able to reach to this compartment part, without having to come out, using the internal access that can be fitted or not with a removable closing.

User's luggage is at their disposal, without encumbering the habitable volume, or the lye-on surface of the tent. The compartment can be located at the opposite side or on one of the side of the entrance to the roof tent

### The 8 Sheets Annexed Drawings Illustrate the Invention

FIG. 1 shows the closed tent mounted on a vehicle. (Side view)

FIG. 2 is a half section A and B

FIG. 3 is a half section C

FIG. 4 shows the detail J of half section C

FIG. 5 illustrates the open tent, mounted on top of 2 types of vehicles (side view)

FIG. 6 shows the opened tent (face view)

FIG. 7 shows one detail of FIG. 5 and a bracket 14

FIG. 8 is a view of the torsion bars and hinges (face view)

FIG. 9 is a view of the torsion bars, seen from the side according to section GG

FIG. 10 shows detail H of FIG. 8

FIG. 11 shows the section KK of bridge (4) and lock (20)

FIG. 12 is a part view C (FIG. 3)

FIG. 13 shows a closed tent on top of a vehicle (side view)

FIG. 14 shows an open tent on top of a vehicle (side view) with the trunk open, in a close-up view

FIG. 15 is a closed tent on top of a vehicle (face view)

FIG. 16 shows a tent getting opened on top of a vehicle (face view)

FIG. 17 is an open tent on top of a vehicle (face view)

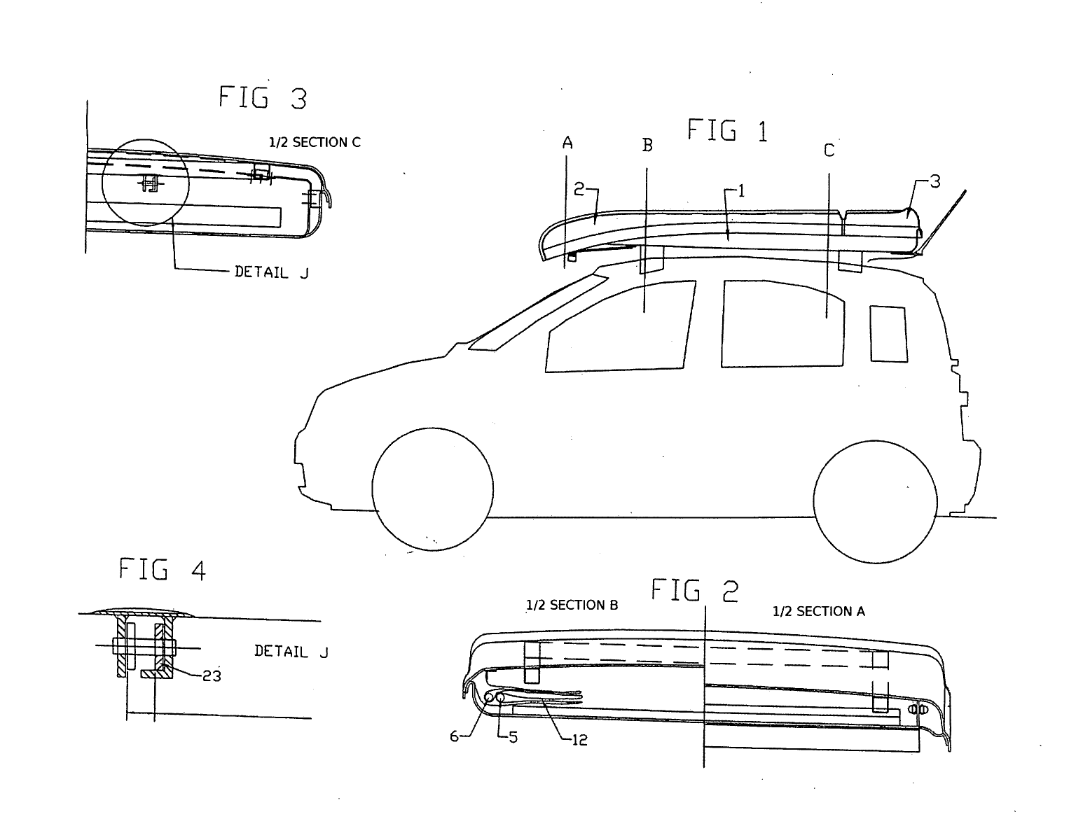

### One Way of Constructing this Invention is as Follows

The roof tent includes a rigid cover (2), rotating towards the front when carrying out the opening/closing, rotation of about 200° around an horizontal axis, located at the front of the roof, this cover drives in its motion the deploying of the side panels, and the ceiling panel of the tent, creating a large liveable space located over the roof and the bonnet of the vehicle.

The roof tent is attached to the roof bars of the vehicle.

The base (1) is a shell made of stratified resin or copolymer vacuum forming (ABS, PVC etc.) straightened in its flat area by a sandwich panel, glued or immersed. An aluminium angle is attached to the front part, it is a bracket for the fix parts of the rotation axle (21) brackets (14). It includes also the loops supports (5 and 6)

The cover (2) is a shell made of stratified resin or copolymer vacuum forming (ABS, PVC etc.) It is straightened with a metal frame, attached, glued or immersed depending on the manufacture. This frame holds the articulated floor (8), the ladder (11) through the rods (23), the shield's fixtures (1 5) and the mobile bearing/spring supports (18), that holds the torsion bars (13).

The cover (3) of the rear compartment is a part made of stratified resin or copolymer vacuum forming. It is attached to the base by means of 2 anti-lifting pins at front and one ¼ turn (19) at the rear part.

There is a U-shape plate (4), attached to the base which ensures straightness of the compartment and also has a function of gutter between the tent cover (2) and the compartment's cover (3) when closed. This metal u-shape part (4) holds both the two locks (20)

The two loops (5 and 6) are made of metal bent tube.

The bed's base (7) is hinged to the base by a metal hinge connection. It can be made of a sandwich panel. It is bracketed by two metal supports (9).

The floor (8) is made of a sandwich panel or other flooring. It is bracketed by two metal supports (10)

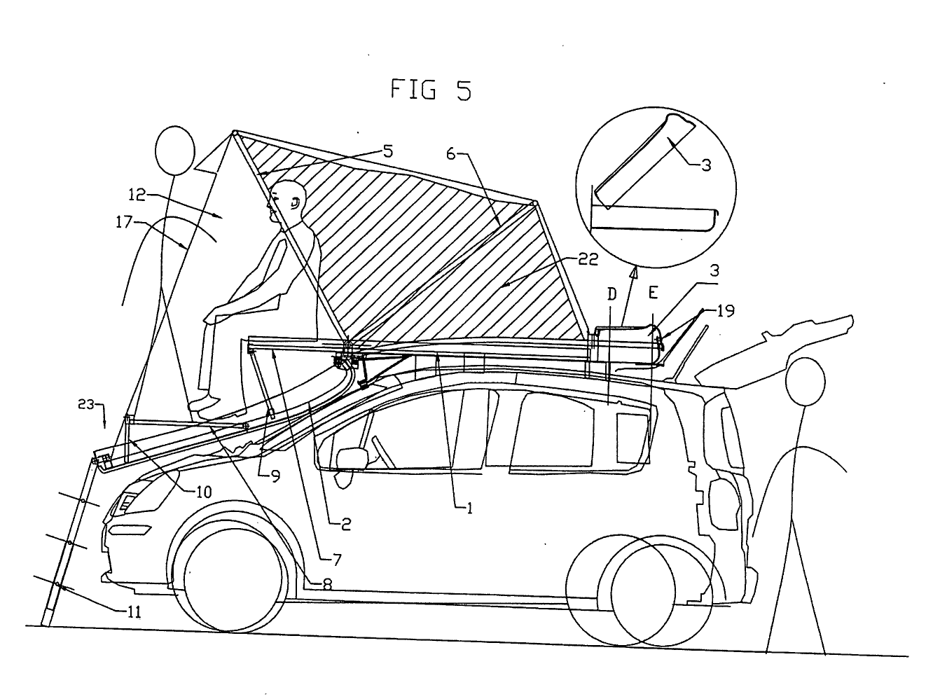

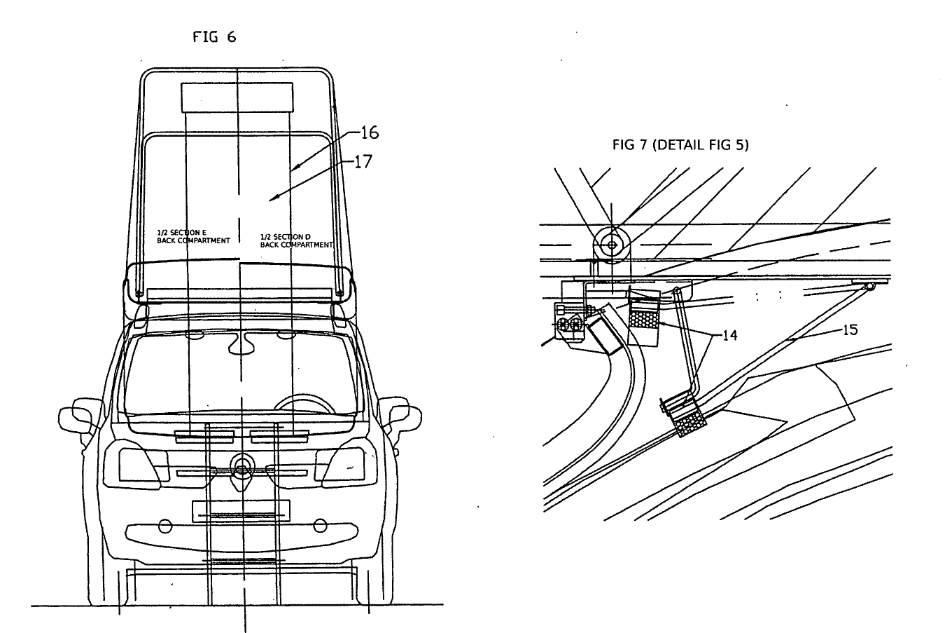

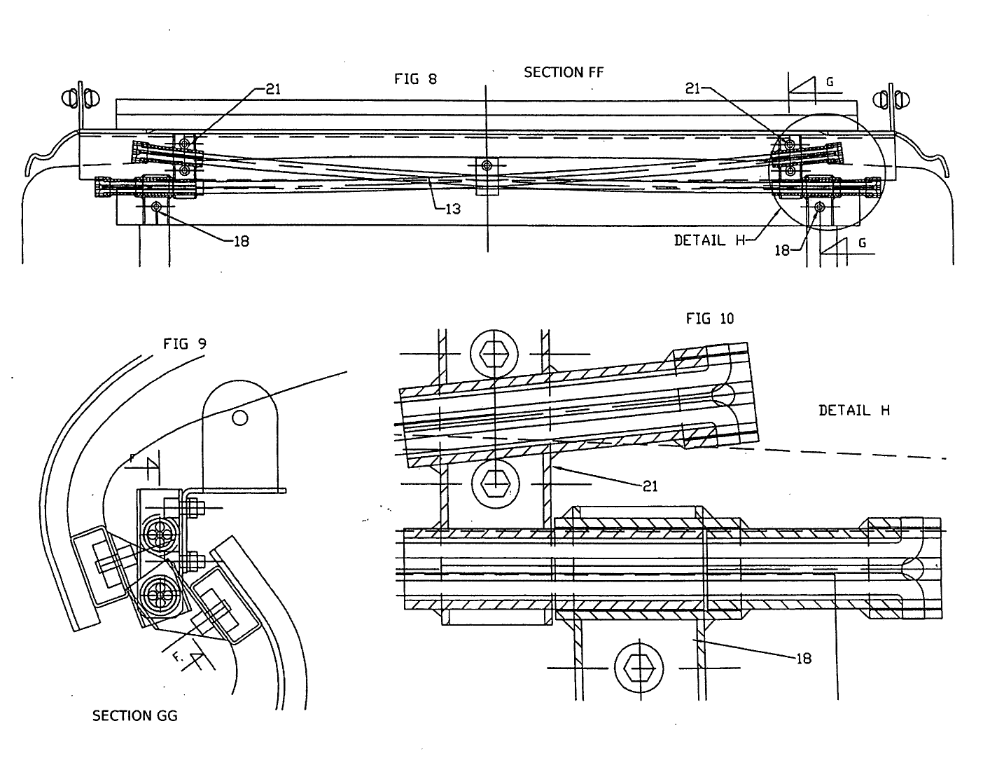

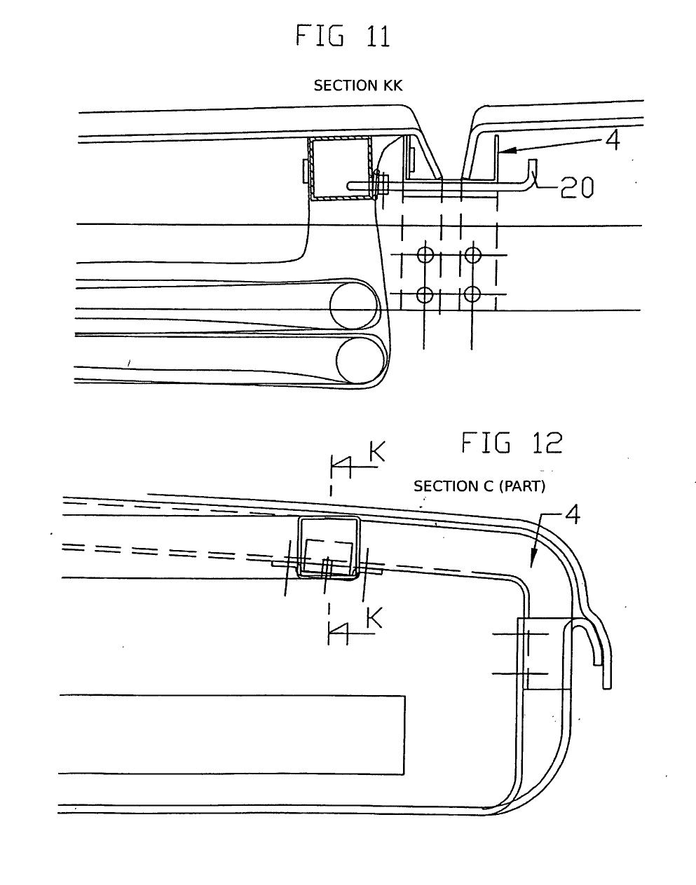

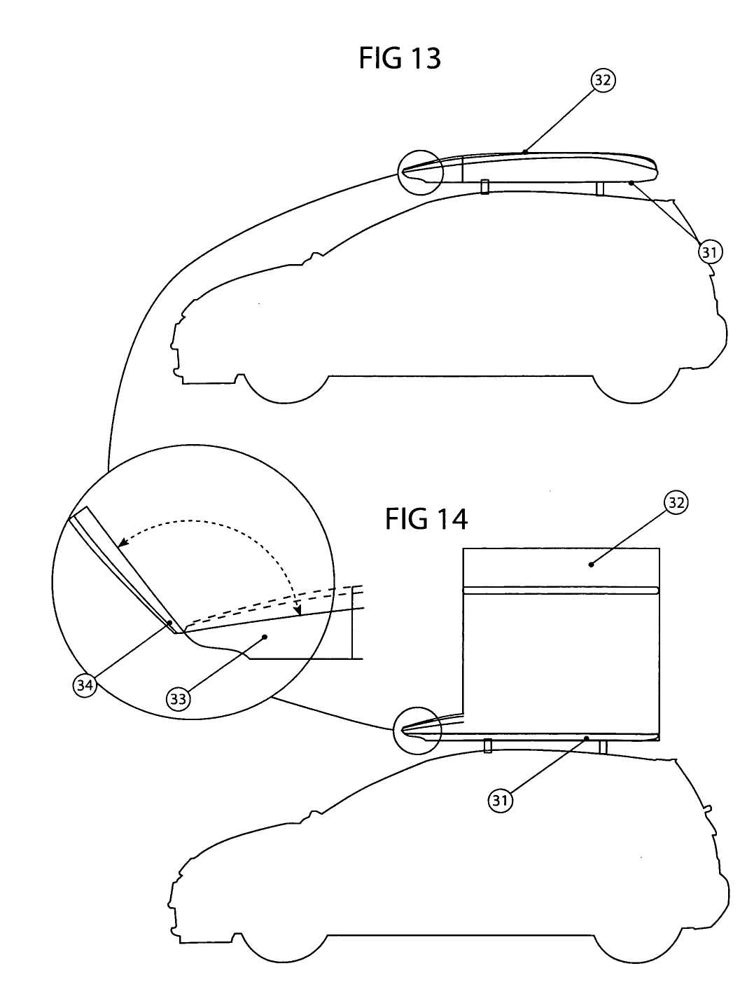

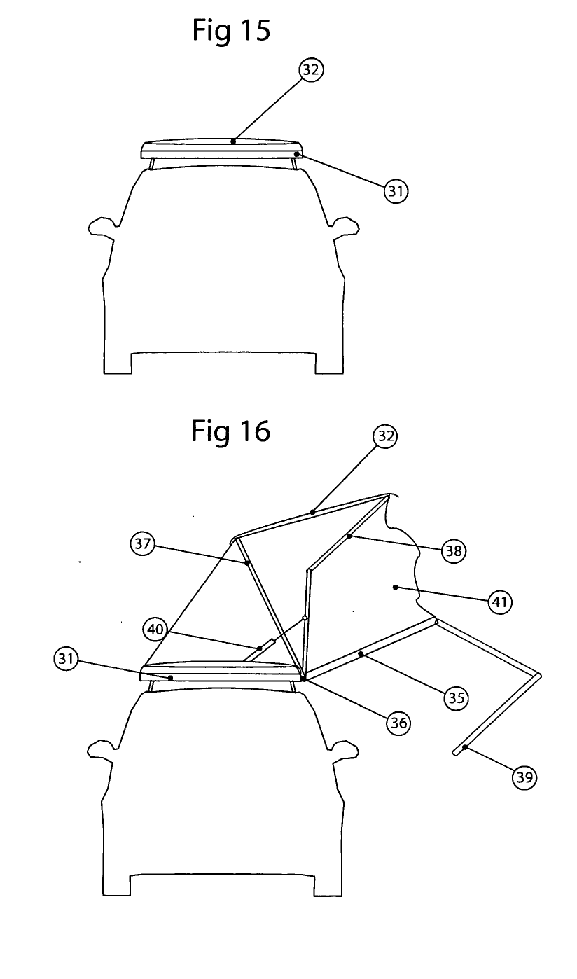

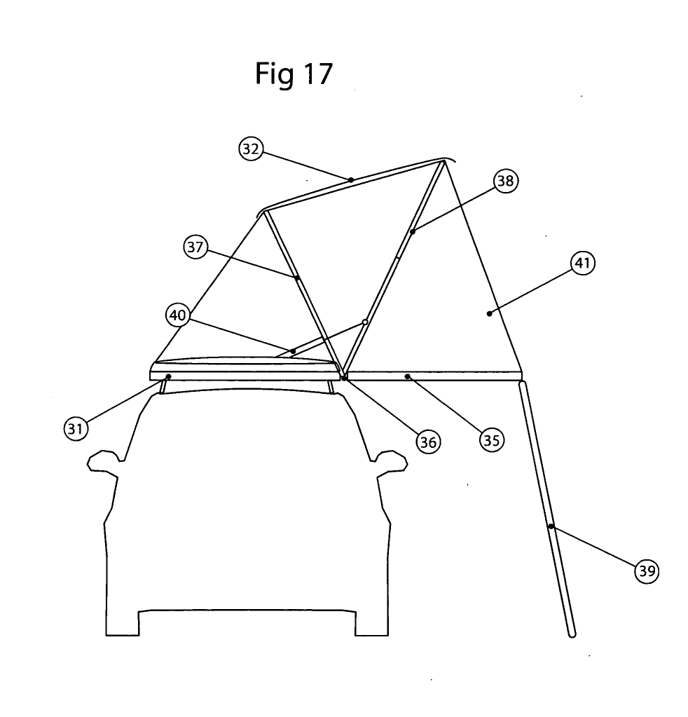

A ladder (11) is connected to the frame (2) by means of 2 rods (23), allowing the ladder rotation axis to be out of the inside, so the ladder can be either inside, or outside of the shell (2). An anti-lifting bracket holds the ladder in its locked outside position (see FIG. 4 and 5). The height of this ladder is variable, due to 2 adjusting sleeves. There is a lock to connect it to the floor (8) in the fold-in position.

The tent fabric (12) is connected all around to the base (1), to the u shape part (4) and to the cover (2) in a waterproof way. There are two eyelets, to give way to the locks (20), with a cloth piece protection for the rain.

The shade cloth (22) is connected to the tent material (12) by “Velcro” type attachment.

The roof tent is equipped with one or several spring torsion bars (13) or one or several flexion plates set on, or near, the rotation axis between base and rigid cover, ensuring part of the balancing of the weight of the rigid cover and the accessories, when opening or closing of the tent is carried out.

Torsion bars (13) are made of 4 piano wires rotating around a metal or polyamide core. Ends of piano wires are bent so to be driven, or caught, in rotation by the rotating brackets (18) or fix axles of hinges (21).

The roof tent is equipped with a shoe (14) whose function of bracket ensures laying the cantilever weight of base (1) on to the vehicle windshield.

The bracket shoe (14) is an aluminium rectangular tube, bent, and including a gum pad glued to the contact face. It is hinged to a bent bar (15). Weight loads are supported by two legs.

Two straps (16) are attached to the loops (5 and 6) and to the cover (2) and also to the u shape part (4).

Another embodiment (see FIG. 5) shows that the rear compartment could be more roomy

The roof tent according to this invention is particularly intended for those who wish to do touring camping by car.

Another Way of Constructing this Invention is as Follows:

The roof tent has a rigid cover (32) that rises over the base (31) when the opening or closing manoeuvre is carried out by the means of four brackets, two of them in the shape of compass (38), thus constituting the roof of the tent, and at the same time the folding floor (35) whose area dimension is similar to the base deploys out on one side at an angle of 180°, resting on an access ladder (39), driving, in that motion, the deploying of side panels (41), and making a floor at the same level than the base (31), the opened assembly offering a volume sufficient to accommodate two lying persons

The roof tent is attached to the roof bars of the vehicle.

The base (31) is a shell made of stratified resin or copolymer vacuum forming straightened in its flat area by a sandwich panel glued or immersed. The base includes at the front the bottom of the luggage compartment part (33), and on one side the hinge (36) that allows the articulation of the folding floor (35) and brackets (37 and 38)

The cover (32) is a part made of stratified resin or copolymer vacuum forming (ABS, PVC etc.)

The cover (34) of the luggage compartment is made of stratified resin or copolymer vacuum forming (ABS, PVC etc.) and it is hinged to the base (33)

A ladder (39) is attached to the folding floor (35). The height of this ladder is variable due to two adjusting sleeves.

The roof tent fabric (41) is connected all around to the base (31) and to the folding floor (35).

The portion of fabric (41) constituting the ceiling is located underneath the rigid cover (32), at a distance sufficient to let outside air flow through the gap between cover and fabric. This ceiling includes a big opening (42), fitted with or without a mosquito net, and adjustable with a flap of fabric (43), thus ensuring control of tent inside aeration, and so avoiding condensation of the internal humidity all over the tent fabric.

Two gas springs (40) are assisting the opening and closing of the tent.

The roof tent according to this invention is particularly intended for those who wish to do touring camping by car or other outdoors activity.

What is claimed is:

1) A folding roof tent for motor vehicle characterized in that it is equipped with a compartment, used in particular for luggage, whose access to is possible either from the inside of the tent, or from outside when the tent is closed.

2) A folding roof tent for motor vehicle characterized in that it comprises a rigid cover (32) that becomes the roof of the tent whenever this one is open, and a fabric (41) whose part of it that is the ceiling is located under the rigid cover (32), at a distance from this one sufficient to allow airflow between fabric and cover, and comprises a big opening (42) fitted with a mosquito net, and adjustable by means of a flap of fabric (43) so as to control aeration of the tent and avoid condensation of the internal humidity, all over the tent fabric.

3) A folding roof tent for motor vehicle as claimed in claim 1 characterized in that the compartment can be located at the opposite side or on one of the side of the entrance to the roof tent

4) A folding roof tent for motor vehicle as claimed in claims 1 and 3 characterized in that it comprises a rigid cover (2,32), a base (1, 31) and a cover for the compartment (3,34)

5) A folding roof tent for motor vehicle as claimed in claims 1,3 and 4, characterized in that it is equipped with a U shape plate (4), attached to the base (1, 31) which ensures straightness of the compartment, and also has a function of gutter between the tent cover (2, 32) and the compartment's cover (3, 34) when closed

6) A folding roof tent for motor vehicle as claimed in claims 1, 3, 4 and 5 characterized in that it includes a rigid cover (2), rotating towards the front when carrying out the opening/closing, rotation of about 200° around an horizontal axis, located at the front of the roof, this cover drives in its motion the deploying of the side panels, and the ceiling panel of the tent, creating a large liveable space located over the roof and the bonnet of the vehicle.

7) A folding roof tent for motor vehicle as claimed in claims 1, 3, 4, 5 and 6 characterized in that it is equipped with a shoe (14) whose function of bracket ensures laying the cantilever weight of base (1) on to the vehicle wind shield.

8) A folding roof tent for motor vehicle as claimed in claims 1, 2, 3 and 4 characterized in that it comprises a rigid cover (32) that rises over the base (31) when the opening or closing manoeuvre is carried out by the means of four brackets, two of them in the shape of compass (38), thus constituting the roof of the tent, and at the same time the folding floor (35) whose area dimension is similar to the base deploys out on one side at an angle of 180°, resting on an access ladder (39), driving, in that motion, the deploying of side panels (41), and making a floor at the same level than the base (31), the opened assembly offering a volume sufficient to accommodate two lying persons.

9) A folding roof tent for motor vehicle as claimed in any of claims 4 to 8 characterized in that it is equipped with one or several spring torsion bars (13) or one or several flexion plates set on, or near, the rotation axis between base and rigid cover, ensuring part of the balancing of the weight of the rigid cover and the accessories, when opening or closing of the tent is carried out.

10) A folding roof tent for motor vehicles as claimed in any one of claims 1 to 9, which is attached on roof bars of aforesaid vehicles.
